(19) United States
(12) Patent Application Publication
(10) Pub. No.: US 2008/0008878 A1
(43) Pub. Date: Jan. 10, 2008

(54) Coated airplanes and rockets

(76) Inventor: George Henry Weeks, Danbury, CT (US)

Correspondence Address: GEORGE WEEKS, 9 SPRUCE MOUNTAIN TRAIL, DANBURY, CT, 06810, US

(21) Appl. No.: 11/482,942

(22) Filed: Jul. 10, 2006

(51) Int. Cl. B32B 17/10; B32B 27/00

(52) U.S. Cl. 428/339; 428/421; 428/422; 428/457

(57) ABSTRACT

Aircraft and rockets with a friction reducing coating are described. The coating imparts several beneficial properties to the aircraft or rocket such as increased fuel economy or higher overall speeds. While it is preferred to coat as much of the aircraft as possible, partial coatings will also have beneficial properties. The preferred coating is polytetrafluoroethylene.

### REFERENCES CITED

U.S. Pat. No. 6,171,704 to Mosser et al.; Jan. 9, 2001 “Coating for Aerospace Aluminum Parts”

U.S. Pat. No. 5,105,744 to Petrovich; Apr. 21, 1992 “Jacketed Projectile for Ammunition”

U.S. Pat. No. 4,684,577 to Coq; Aug. 4, 1987 “Non-stick Silicone Blend Coating”

Specification: Coating an airplane or a rocket with a nonstick or friction reducing agent will impart beneficial properties to that airplane or rocket. A great deal effort has been devoted to decreasing the drag of airplane by manipulation of the physical characteristics of the surface such as by streamlining the body. Friction to a particular body (ie airplane or rocket) caused by a fluid that body is traveling through is caused by at least two factors. One is the physical shape of that body and how well it allows that fluid to flow around it. The other factor is force necessary for the fluid to flow across the surface of the moving body ie the attraction of the fluid for the surface of the moving body. Consider the metal surfaces on the interior of automobile engine. Without a lubricant in an automobile engine, metal surface rubbing against one another generate enough heat from friction to weld themselves together. However, very little attention has been paid to the chemical properties of the surface itself or more precisely to the friction caused by movement of air along the surface of the airplane; that is, because of air's omnipresence, people tend to ignore effects due to it. However, this effect can make significant contribution. For example, many meteorites plunging to earth burn up because of the friction with the earth's atmosphere. The space shuttle is covered with ceramic tiles on one surface to prevent it from burning up upon reentering the earth's atmosphere. An even closer example is the SR-71, “Blackbird”. Before takeoff, this airplane leaks a good quantity of fuel; this is not a mistake in the design but an intentional byproduct of the design. Although its normal operating speed (Mach 3+) is much higher than commercial planes, it also operates at much higher attitudes (thinner air), yet the friction is intense enough to heat the fuselage and seal the fuel leaks (due to thermal expansion). Still another example is the vibrations in airplane caused by compression of air when planes (that is, in the late 1940's airplane) were approaching the speed of sound. The reduction in friction can ultimately produce several advantages which are interrelated: (1) the top speed of the airplane (such as a fighter airplane) can be improved, or (2) the fuel economy of a commercial plane can be improved (i.e. operating at the same speed). This effect can be easily seen by comparison of the force need to slide two identical blocks of material over a regular surface and one covered with a nonstick material. In the present case, the block of material is substituted by air. While a rocket is much simpler in design than an airplane, it generally travels at much higher speeds than an airplane, therefore, coating its surface can likewise enhance its performance. Teflon coating bullets also demonstrate the advantages of coating a projectile (for example U.S. Pat. No. 5,105,744 to Petrovich) although this analogy is weak. Teflon coated bullets have been called the cop-killer bullets because of their ability to penetrate a Kevlar “bulletproof” vest. These bullets have this ability because the Teflon coating decreases the friction between the bullet and the barrel of a gun considerably and thereby increases the velocity of the bullet (giving it greater penetrating ability).

On a molecular basis, friction can be accounted for from the adhesion of substances like oxygen, nitrogen and water vapor to the metal fuselage of the airplane. The interaction between metals and gases is well known in chemistry; for example, hydrogenations can only be accomplished in the presence of metals like platinum, palladium and nickel. Many metals are surfaced oxidized which shows their interaction with oxygen; for example, aluminum is chemically very reactive but does not react under ordinary circumstances because of a surface coating due to oxidation prevents further reaction. Of course, ordinary iron and steel while initially bright and shiny quickly obtained the reddish brown coating of rust because of the attraction of the metal for oxygen. This adhesion is seen in many instances such as the wetting of surfaces by water as opposed to some surface (such as Teflon surfaces) where the water actually beads.

In summing up, a number of factors can be identified as determining the amount of friction a particular moving object has: (1) its shape (that is, whether it is streamlined or not); (2) the adhesion of the fluid it is passing through to its surface (that is, the adhesion of air to the metallic surface of a plane or the adhesion of water to the plastic, wood or metal surface of a boat); (3) the density of the fluid, and (4) the speed of the moving object. Factors 3 and 4 are interrelated; the higher the speed of an object, the greater it compresses the fluid in front of it and the more compression the higher the density. It should also be understood that the greater the speed of an aircraft, the greater it will benefit from a friction reducing coating; that is, a private small plane traveling at 120 miles per hour will only minimally benefit from a friction reducing coating while a Boeing 747 traveling at 600 miles per hour will benefit more and a fighter plane traveling at 2000+ miles per hour will benefit the most.

Another benefit from coating an airplane with a nonstick agent would be to reduce the adherence of ice and snow to the airplane. The airline disaster in Washington D.C. in January, 1982 is known to have been caused by excessive ice and snow greatly increasing the weight of the plane upon takeoff. Currently, during snowstorms, airplanes are deiced with hot ethylene glycol to prevent a reoccurrence of the disaster of 1982.

Many friction reducing coating materials are possible for use in this application and this list is not inclusive. However, the preferred coating would be one which is permanent such as the Teflon coating on frying pans. The preferred material for coating is Teflon (polytetrafluoroethylene). Other useful fluorocarbon polymers are those made from hexafluoropropylene, perfluoroalkoxyvinyl ether, copolymers of tetrafluoroethylene and hexafluoropropylene, copolymers of tetrafluoroethylene and perfluoroalkoxyvinyl ether, ethylenetetrafluoroethylene, vinylidene fluoride, ethylchlorotrifluoroethylene, copolymers of ethylene and tetrafluoroethylene and mixtures thereof. Silicone coatings which have been used as friction reducing coatings such as described in U.S. Pat. No. 4,684,577 to Coq may reduce some friction but because of the silicone structure will show more adhesion to oxygen and water then fluorocarbon polymers and their ability to reduce friction in this application should be far less. The techniques for coating a metal with Teflon are well known as demonstrated by commercially available Teflon coated frying pans. Likewise, many friction reducing materials are not suitable for this application; many lubricants work by molecules of the lubricant covering two surfaces (which would be rubbing on each other) and sliding with respect to each other e.g. motor oil covers two metal surfaces which it lubricates and the motor oil molecules move relative to each other and thereby reduce friction. Obviously, this type of friction reduction is unsatisfactory for the present application. Additionally, these types of lubricants would increase a fire hazard. However, polyfluoropolymers such as Teflon reduce friction because of their lack of chemical reactivity and, therefore, lack attraction by other molecules such as water or oxygen. The thickness of the fluorocarbon polymer coating can vary widely from a few micrometers to several millimeters. However, the optimum thickness for the coating will be such that minor abrasions by flying debris are prevented. Coating the metal surfaces of aircraft is a common technique to reduce drag by filling in any rough surfaces and thereby improving the overall aerodynamic quality of the aircraft. The fluorocarbon polymer coating of this invention is not performing this function but it can be used with other coatings which perform this function. For example, an aircraft can be coated with one or several materials to improve it's aerodynamic quality and on top of this (outermost), a fluorocarbon polymer is subsequently applied. It is well known that additives and fillers can be mixed with fluorocarbon polymers to improve certain physical and/or mechanical properties. Such fillers include but are not limited to glass fibers, carbon, graphite and molybdenum disulphide and generally improve the mechanical strength, stability, and/or wear resistance of the composite.

Clearly, the most advantageous situation is to coat an airplane as completely as possible with a friction reducing agent. It is also obvious that certain parts can not be coated such as windows and engine parts. However, some of the benefits of this treatment might be obtained by coating selective surfaces of an airplane; for example the leading edges (that is, the surfaces shown in a frontal view of the airplane) in which air initially contacts the plane may be sufficient to obtain a high percentage of the beneficial effects of this treatment. These surfaces are the ones which produce a large percentage of the drag.

Coating just the leading edges of an airplane would be similar to covering the leading edges of a satellite with ceramic tiles for reentry into the atmosphere because most of the friction occurs at that surface. Another variation would be to coat the upper surface of wings. It is well known that the lift of airplane is produced by the variation of pressure caused by the different speeds of air over the upper and lower surfaces of the wings. Air moving at faster speeds creates a lower pressure; consequently the top surface of a wing is curved and requires air travel a longer distance than across the lower surface. By coating the upper surface and not the lower surface, their would be less resistance to air flow across the upper surface and lift is improved.

What is claimed is:

1. Airplanes and rockets with a substantial percentage of the outermost surfaces coated with a fluorocarbon polymer.

2. The fluorocarbon polymer of claim 1 is polytetrafluoroethylene.

3. The fluorocarbon polymer of claim 1 is hexafluoropropylene, perfluoroalkoxyvinyl ether, copolymers of tetrafluoroethylene and hexafluoropropylene, copolymers of tetrafluoroethylene and perfluoroalkoxyvinyl ether, ethylenetetrafluoroethylene, vinylidene fluoride, ethylchlorotrifluoroethylene, copolymers of ethylene and tetrafluoroethylene and mixtures thereof.

4. The airplanes and rockets of claim 1 where the fluorocarbon polymer coating has a thickness between one micrometer and one millimeter.

5. The airplanes and rockets of claim 1 where the fluorocarbon polymer is bonded to the airplane or rocket surface.

6. The airplanes and rockets of claim 1 where the fluorocarbon polymer is the outermost coating of several layers of coatings on the metal bodies of the airplanes and rockets

7. The fluorocarbon polymer of claim 1 contains one of more additives up to 25% by weight of the composite.

8. The additives of claim 7 are glass fibers, carbon, graphite and molybdenum disulphide.

9. Airplanes and rockets with those outermost surfaces, which produce a substantial percentage of the entire drag, coated with a fluorocarbon polymer.

10. The fluorocarbon polymer of claim 7 is polytetrafluoroethylene.

11. The fluorocarbon polymer of claim 9 is hexafluoropropylene, perfluoroalkoxyvinyl ether, copolymers of tetrafluoroethylene and hexafluoropropylene, copolymers of tetrafluoroethylene and perfluoroalkoxyvinyl ether, ethylenetetrafluoroethylene, vinylidene fluoride, ethylchlorotrifluoroethylene, copolymers of ethylene and tetrafluoroethylene and mixtures thereof.

12. The airplanes and rockets of claim 9 where the fluorocarbon polymer coating has a thickness between one micrometer and one millimeter.

13. The airplanes and rockets of claim 9 where the fluorocarbon polymer is bonded to the airplane or rocket surface.

14. The airplanes and rockets of claim 9 where the fluorocarbon polymer is the outermost coating of several layers of coatings on the metal bodies of the airplanes and rockets

15. The fluorocarbon polymer of claim 9 contains one of more additives up to 25% by weight of the composite.

16. The additives of claim 15 are glass fibers, carbon, graphite and molybdenum disulphide.

17. Airplanes and rockets with those outermost surfaces, which produce a large percentage of the drag, coated with a fluorocarbon polymer.

18. A method for increasing the fuel efficiency and/or the top speed of airplanes and rockets is claimed.

19. A method for reducing the buildup of ice and snow on aircraft is claimed.
